(19) United States
(12) Patent Application Publication
(10) Pub. No.: US 2026/0146532 A1
(43) Pub. Date: May 28, 2026

(54) METHOD OF ENHANCED SEISMIC-GUIDED PROPERTY PREDICTION

(71) Applicant: CHINA PETROLEUM & CHEMICAL CORPORATION, Beijing (CN)

(72) Inventors: Jinjun LIU, Houston, TX (US); Tao LIU, Beijing (CN); Hong ZHANG, Beijing (CN)

(21) Appl. No.: 19/399,858

(22) Filed: Nov. 25, 2025

Related U.S. Application Data
(60) Provisional application No. 63/724,519, filed on Nov. 25, 2024.

(51) Int. Cl. E21B 49/08; E21B 47/002; G01V 1/30

(52) U.S. Cl. CPC E21B 49/087; E21B 47/0025; G01V 1/30; E21B 2200/20; E21B 2200/22

(57) ABSTRACT

A method for predicting a property of a subsurface formation, includes: drilling one or more wellbores into the subsurface formation at a well location; conducting a seismic survey at the well location to construct a primary seismic image volume, the primary seismic image volume dataset comprises at least a pressure wave velocity vₚ, a shear velocity vₛ, and a density rho, in both time and frequency domains; conducting well logging at the one or more wellbores to generate logging information at the well location; generating an auxiliary seismic image volume for seismic-guided property prediction using Kriging at the well location; generating a prediction operator based on the primary seismic image volume, the auxiliary seismic image volume and the well logging information; feeding a seismic image volume and the prediction operator into a property prediction engine; and generating the predicted property of the subsurface formation.

### FIELD OF DISCLOSURE

The present disclosure relates to a method for generating enhanced seismic-guided property prediction, and in particular to a method involving generating auxiliary input data for seismic-guided property prediction using Kriging.

### BACKGROUND

In the field of hydrocarbon exploration and development, seismic data acquisition and processing play a critical role in delineating subsurface geological formations and characterizing reservoir properties.

The process commences with the acquisition of seismic data, which is subsequently processed to generate high-resolution three-dimensional volumes of subsurface properties. These volumes may include, but are not limited to, seismic propagation velocity models, anisotropy parameters, attenuation (or absorption) coefficients, porosity distributions, and seismic reflectivity models. The integration of these geophysical property volumes enables a comprehensive and effective interpretation of the subsurface structure, thereby facilitating informed decision-making in exploration and field development activities.

Seismic data processing workflows generally involve a sequence of inversion and imaging steps. Initially, seismic inversion methods are employed to construct propagation velocity models that resolve long-to intermediate-wavelength features of the subsurface. These velocity models are essential for accurate wavefield extrapolation and serve as the foundation for subsequent imaging processes. Following velocity model building, seismic migration algorithms are applied to the recorded data to generate high-resolution seismic reflectivity images, which capture the short wavelength features corresponding to geological interfaces and heterogeneities. The resulting seismic reflectivity images provide detailed spatial information regarding the location, geometry, and extent of potential hydrocarbon-bearing formations, and are instrumental in evaluating the storage capacity and distribution of oil and gas resources. Such information directly informs and optimizes exploration strategies, well placement, and drilling operations.

To achieve high-fidelity seismic reflectivity images with sufficient spatial resolution and accuracy, it is necessary to employ high-multifold seismic acquisition systems. These systems are designed to collect dense and redundant seismic measurements, thereby enhancing signal-to-noise ratios and improving data coverage. Moreover, the construction of accurate seismic velocity models-characterized by correct kinematic attributes and representative of true subsurface conditions—is a prerequisite for successful seismic migration and imaging. High-quality velocity models ensure that the subsequent migration step yields reliable and interpretable reflectivity images, which are crucial for resource evaluation and risk mitigation in hydrocarbon exploration.

Existing seismic velocity inversion methodologies primarily encompass ray-based seismic tomography and full waveform inversion (FWI) techniques. Ray-based tomography, which relies on the approximation that seismic energy propagates along discrete ray paths, is computationally efficient and generally yields smooth subsurface velocity models. Such models are often adequate for resolving geologic targets characterized by relatively simple structural configurations, including shallow sedimentary environments where lateral velocity variations are minimal and the subsurface is largely homogeneous.

However, the inherent limitations of ray-based tomography become pronounced when applied to geologically complex settings. In environments featuring strong lateral heterogeneity, abrupt velocity contrasts, or intricate structural geometries-such as salt domes, sub-basalt formations, overthrust belts, and foothill regions—the ray-based approach fails to accurately resolve the true subsurface velocity distribution. The simplifications inherent to ray theory result in inadequate model resolution and significant errors in areas where wavefront distortion, multipathing, and scattering effects are dominant.

To address these challenges, full waveform inversion (FWI) has emerged as a robust and indispensable tool for seismic velocity model construction in complex geological environments. FWI leverages the complete seismic waveform, incorporating amplitude, phase, and frequency content, thereby enabling the recovery of high-resolution velocity models that capture both large-scale and fine-scale subsurface features. By iteratively minimizing the misfit between observed and modeled seismic data through the direct solution of the seismic wave equations, FWI accounts for the full physics of wave propagation, including transmission, reflection, diffraction, and mode conversion phenomena. As a result, FWI can produce accurate and geologically realistic velocity models in settings where ray-based tomography is inadequate, thereby facilitating enhanced subsurface imaging and more reliable reservoir characterization.

Full Waveform Inversion (FWI) operates by directly solving the seismic wave equations and iteratively matching the observed seismic data with synthetic data generated from a subsurface model. This approach enables the construction of highly accurate seismic propagation velocity models that are particularly effective in representing complex subsurface geological structures, including those associated with salt bodies, overthrust regions, and other areas exhibiting strong lateral heterogeneity or abrupt velocity contrasts. The resultant velocity models from FWI serve as the foundation for generating precise and high-resolution seismic reflectivity images through advanced seismic migration algorithms. These reflectivity images facilitate detailed delineation of geological interfaces and heterogeneities, thereby supporting the accurate interpretation and characterization of hydrocarbon reservoirs.

Moreover, the high-fidelity velocity models produced by FWI are instrumental in time-lapse (4D) seismic monitoring, enabling the detection and quantification of dynamic changes within hydrocarbon reservoirs over the course of production. This capability is crucial for optimizing reservoir management, enhancing recovery strategies, and mitigating associated risks. In addition to their role in migration-based imaging, FWI-derived models can be directly utilized to generate high-resolution seismic image volumes, commonly referred to as FWI images. These FWI images provide an unprecedented level of detail regarding subsurface properties, as they incorporate the full physics of wave propagation-capturing both large-scale and fine-scale features that are often unresolved by conventional imaging techniques. As such, the application of FWI significantly advances the state of the art in subsurface imaging and reservoir property characterization, offering a robust and comprehensive toolset for exploration and field development activities.

### SUMMARY

According to an embodiment of the disclosure, a method for predicting a property of a subsurface formation is disclosed. The method includes the steps of: drilling one or more wellbores into the subsurface formation at a well location; conducting a seismic survey at the well location to construct a primary seismic image volume, the primary seismic image volume dataset comprises at least a pressure wave velocity vₚ, a shear velocity vₛ, and a density rho, in both time and frequency domains; conducting well logging at the one or more wellbores and obtaining logging information at the well location; generating an auxiliary seismic image volume for seismic-guided property prediction using Kriging at the well location; generating a prediction operator based on the primary seismic image volume, the auxiliary seismic image volume and the well logging information at the well location; generating the predicted property of the subsurface formation using the prediction operator and a second seismic image volume. The second seismic image volume can be the same as the primary seismic image volume or obtained by seismic survey in an area that differs from where the primary seismic image volume is obtained from.

According to an embodiment of the disclosure, the generating an auxiliary seismic image volume step further includes steps of: deriving P impedance from the primary seismic image volume at the well location through seismic inversion in both time and frequency domains. According to an embodiment of the disclosure, the generating an auxiliary seismic image volume step further includes: extracting high frequency components of the primary seismic image volume in wavelet transform domain.

According to an embodiment of the disclosure, the generating an auxiliary seismic image volume step further includes: producing instantaneous frequency map from the extracted high frequency components of the primary seismic image volume.

According to an embodiment of the disclosure, the generating an auxiliary seismic image volume step further includes: convolving the primary seismic image volume with a wavelet with the dominant frequency content.

According to an embodiment of the disclosure, the generating an auxiliary seismic image volume step further includes: producing the auxiliary seismic image volume at the well with coherence with the primary seismic image volume at the well.

According to an embodiment of the disclosure, the conducting a seismic survey at the well location to construct a primary seismic image volume step further includes: establishing a well-to-seismic tie. According to an embodiment of the disclosure, the conducting a seismic survey at the well location to construct a primary seismic image volume step further includes: extracting seismic attributes at the well location from the seismic image volume.

According to an embodiment of the disclosure, the high frequency components are indicative of fine-scale geological features. According to an embodiment of the disclosure, the conducting a seismic survey at the well location to construct a primary seismic image volume step further includes: resampling or interpolating the extracted seismic attributes to match sampling intervals of well logs. According to an embodiment of the disclosure, the instantaneous frequency map captures a dominant frequency content at each spatial location. According to an embodiment of the disclosure, the conducting a seismic survey at the well location to construct a primary seismic image volume step further includes: ensuring the seismic dataset at the well location is geologically consistent and free from artifacts or misalignments. According to an embodiment of the disclosure, the conducting a seismic survey at the well location to construct a primary seismic image volume step further includes: ensuring the seismic dataset at the well location is geologically consistent and free from artifacts or misalignments.

According to an embodiment of the disclosure, the method further includes: establishing a pseudo-linear relationship between P impedance and (vₚ, vₛ, rho). According to an embodiment of the disclosure, the method further includes: constructing a prediction operator between the primary seismic image volume dataset and (vₚ, vₛ, rho). According to an embodiment of the disclosure, P impedance/(t)=vₚ(t)·rho(t). According to an embodiment of the disclosure, reflectivity r(t)=I′(t), s(t)=r(t)*w(t), w(t) is wavelet, I(t)=∫r(t)˜∫s(t). According to an embodiment of the disclosure, assuming: I(t)˜vₚ(t)˜vₛ(t)˜rho(t), then ∫s(t)˜vₚ(t)˜vₛ(t)˜rho(t).

According to an embodiment of the disclosure, the prediction operator is generated based on well logging information. According to an embodiment of the disclosure, the prediction operator is generated based on the primary seismic image volume.

### BRIEF DESCRIPTION OF THE FIGURES

The disclosure will now be explained in more detail using exemplary embodiments and with references to the drawings, in which:

FIG. 1 is a is a schematic diagram illustrating a top view of a survey region with the various points of incidence of seismic sources, according to an embodiment in the disclosure.

FIG. 2 is a schematic diagram illustrating a cross-sectional view of an environment with points of incidence of seismic sources, seismic data recording sensors, a well location, a wellbore, the various transmission rays, and the various angles of incidence, according to an embodiment in the disclosure.

FIG. 3 is a schematic diagram illustrating a cross-sectional view of an environment with a wellbore and a well logging tool including one or more sonic generators and one or more well log data recording sensors, according to an embodiment in the disclosure.

FIG. 4 is a schematic diagram illustrating a high-performance computing system, according to an embodiment in the disclosure.

FIG. 5 is a functional block diagram illustrating Kriging workflow using well information, and the property produced by seismic guided property generation, according to an embodiment of the disclosure.

FIG. 6 is a functional block diagram illustrating seismic guided property prediction workflow, according to an embodiment of the disclosure.

FIG. 7 is a flowchart illustrating the method for generating auxiliary data, according to an embodiment of the disclosure.

FIG. 8 compares the results with conventional low frequency model building workflow, showing a bulls-eye effect in panel A, vs. the result without bulls-eye effect in panel B, with the inventive workflow that recovers true geological features, according to an embodiment of the disclosure.

### DETAILED DESCRIPTION

In subsurface reservoir characterization, the construction of accurate low-frequency models is a critical prerequisite for reliable seismic inversion and property prediction workflows. Traditional approaches to low-frequency model building often rely on sparse well data and simplistic interpolation schemes, which may fail to capture the geological complexity and lateral variability inherent in many stratigraphic settings. Moreover, the absence of robust integration between well-log measurements and seismic attributes can result in models that lack geophysical consistency, thereby limiting their predictive utility in reservoir delineation, facies classification, and volumetric estimation.

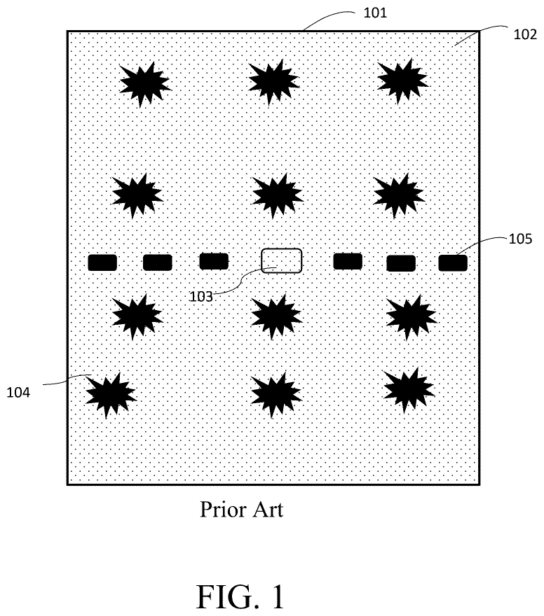

FIGS. 1-4 show exemplary embodiments of methods, apparatuses, and mediums for obtaining and storing seismic data, which is processed to generate one or more high resolution geological models for high resolution images for lithology identification, fluid discrimination, and reservoir characterization of complex subsurface structures of a survey region. The survey region may be subsurface structures under land or subsurface structures under the sea. Seismic data includes, for example, a seismic image volume, which is a three-dimensional representation of the Earth's subsurface created by processing seismic reflection data. Seismic image volume visualizes geological structures and stratigraphy in 3D, enabling interpreters to analyze spatial relationships and identify features like faults, horizons, and reservoirs.

FIG. 1 is a schematic diagram illustrating a top view of a survey region with the various points of incidence of seismic sources, according to an embodiment of the disclosure. More specifically, FIG. 1 illustrates a seismic survey region (survey region) 101, which is a land-based region denoted by reference numeral 102. Reference number 102 denotes the top earth formation of the land-based region 102. Persons of ordinary skill in the art, will recognize that seismic survey regions produce detailed images of local geology to determine the location and size of possible hydrocarbon (oil and gas) reservoirs, and therefore a well location 103. In these survey regions, seismic waves bounce off underground rock formations during emissions from one or more seismic sources at various points of incidence 104. A blast is an example of a seismic source generated by seismic equipment. The seismic waves that reflect back to the surface are captured by seismic data recording sensors 105, transmitted by one or more data transmission systems (frequently wirelessly) from the seismic data recording sensors 105, and stored for later processing and analysis by a high-performance computing system. Although this example shows a top earth formation of a land-based region 102, it is understood that this is only an example, and the methods and system may also be applied to a survey region at the bottom of an ocean.

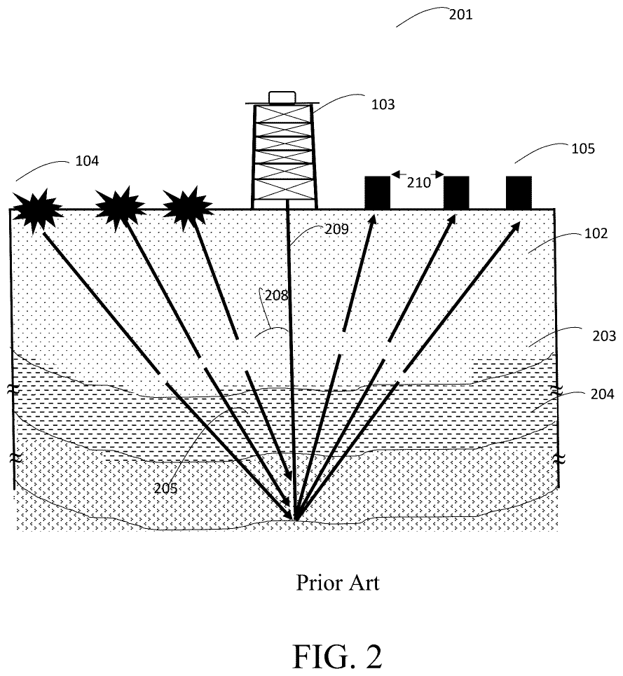

FIG. 2 is a schematic diagram illustrating a cross-sectional view of an environment with points of incidence of seismic sources, seismic data recording sensors, a well location, a wellbore, the various transmission rays, and the various angles of incidence, according to an embodiment in the disclosure. FIG. 2 is a schematic diagram illustrating a cross-sectional view of a seismic survey region 101 in FIG. 1 with points of incidence of seismic sources, seismic data recording sensors (seismic receivers), a well location, a wellbore, the various transmission rays, and the various angles of incidence, according to an embodiment. More specifically, in FIG. 2 a cross-sectional view of a portion of the earth over the seismic survey region is denoted by reference numeral 201, showing different types of earth formations denoted by reference numerals 102, 203, and 204. Although the seismic survey region is based on land in this example, it is understood that this is only an example and that the methods and system may also be applied to a survey region at the bottom of an ocean. FIG. 2 illustrates a common midpoint-style gather, where seismic data are sorted by surface geometry to approximate a single reflection point in the earth. The survey seismic data may also be referred to as traces, gathers, or image gathers. In this example in FIG. 2, data from one or more shots or blasts and receivers may be combined into a single image gather or used individually depending upon the type of analysis to be performed.

As illustrated in FIG. 2, one or more shots or blasts represents seismic sources located at various points of incidence or stations denoted by reference numeral 104 at the surface of the Earth at which one or more seismic sources are activated. Seismic energy or seismic sources from multiple points of incidence 104, will be reflected from the interface between the different earth formations. These reflections will be captured by multiple seismic data recording sensors 105, each of which will be placed at different location offsets 210 from each other, and the well 103. Because all points of incidences 104, and all seismic data recording sensors 105 are placed at different offsets 210, the survey seismic data or traces, also known in the art as gathers or image gathers, will be recorded at various angles of incidence represented by 208. The points of incidence 104 generate downward transmission rays 205, in the earth that are captured by their upward transmission reflection through the seismic data recording sensors 105. Well location 103, in this example, is illustrated with an existing drilled well attached to a wellbore, 209, along which multiple measurements are obtained using techniques known in the art. This wellbore 209, is used to obtain well log data, which may include P-wave velocity, S-wave velocity, Density, among others. Other sensors, not depicted in FIG. 2, may be placed within the survey region to capture seismic data. Seismic data may be used to examine the dependence of amplitude, signal-to-noise, move-out, frequency content, phase, and other seismic attributes, on incidence angles 208, offset measurements 210, azimuth, and other geometric attributes that are important for data processing and imaging of a seismic survey region.

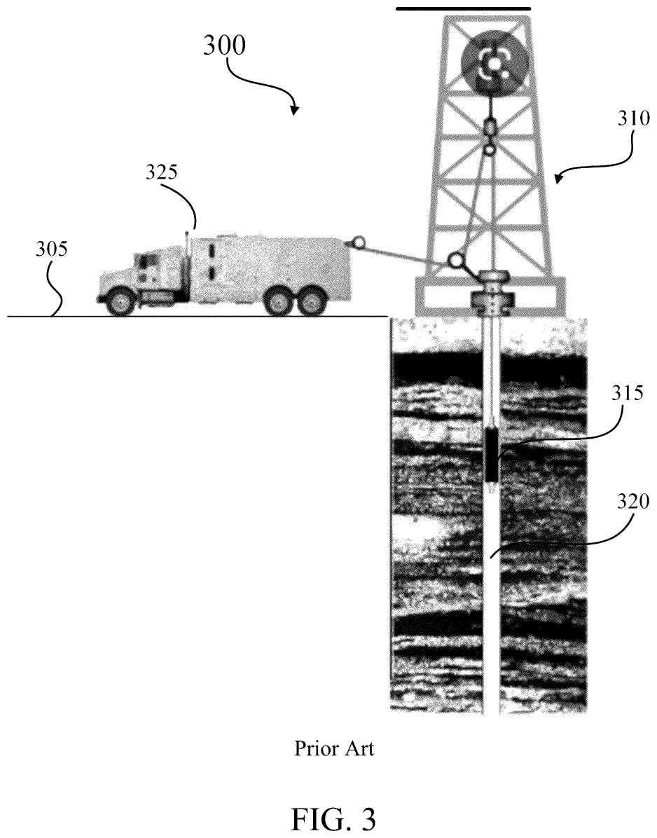

FIG. 3 is schematic diagram illustrating a cross-sectional view of a seismic survey region with a wellbore and well-logging tool including one or more sonic generator and one or more well log data recording sensors according to an embodiment. A sonic generator is an example of equipment to produce one or more sonic waves (sound waves). A sonic generator may be referred to as a sonic source because the sonic generator produces or generates one or more sonic waves (sound waves) which are also referred to as seismic waves. The one or more well log data recording sensors are examples of one or more seismic data recording sensors (seismic receivers or seismic data recorders) and may be the same seismic data recording sensors as seismic data recording sensors 105. In embodiments of the present disclosure, oil and/or gas production is discontinued in order to generate seismic waves and record seismic data including reflections of the seismic waves moving through the subsurface of one or more earth formations in the seismic survey region.

FIG. 3 shows an oil drilling system 300 on land 305 including a drilling rig 310. The drilling rig 310 supports the lowering of a well logging tool 315 into a wellbore 320. The well logging tool 315 may include one or more sonic generators (sonic sources) to generate one or more sound waves, which are transmitted into one or more earth formations to generate reflections or reflection waves in the one or more earth formations. Although this example shows one or more earth formations of a land-based survey region, it is understood that this is only an example and that the methods and systems may also be applied to a survey region at the surface or bottom of a body of water such as an ocean. The well logging tool 315 also includes one or more well log data recording sensors. As discussed above, the one or more well log data recording sensors receive and record well log data, which includes reflection data received by the one or more well log data recording sensors in response to the sound waves transmitted into one or more earth formations by the one or more sonic generators. The well-log data is an example of seismic data. The well log data may include compression wave velocity or P-wave velocity (Vp), shear wave velocity (Vs), and density (Rho), which is an indicator of porosity. This well logging process to record well log data may also be referred to as sonic logging. A vehicle 325 may be coupled to the well logging tool 315 to assist in the lowering and raising of the well logging tool 315 as well as communicating with the well logging tool 315 to obtain well log data. Alternatively, in methods and systems for a survey region at the surface or bottom of a body of water such as an ocean, another device or system may use to assist in the lowering or raising of the well logging tool 315 as well as communicating with the well logging tool 315 to obtain well log data.

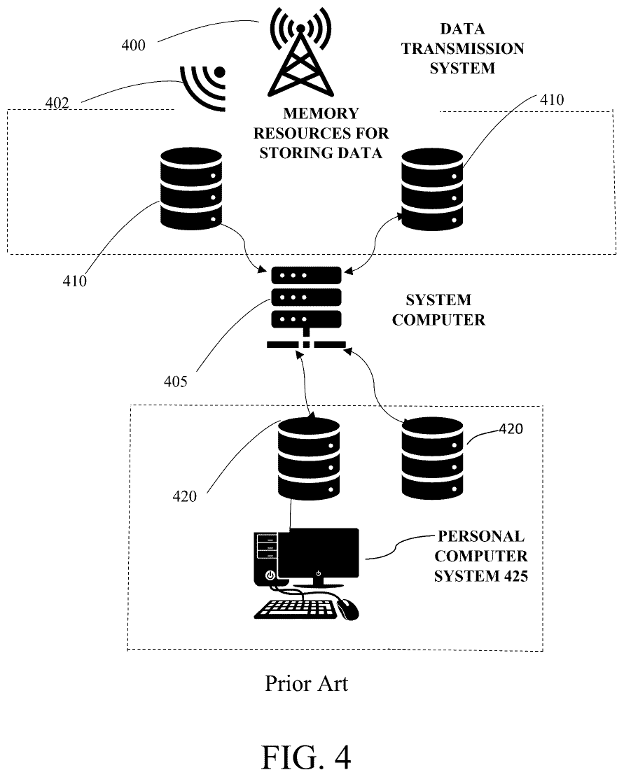

FIG. 4 is a schematic diagram illustrating a high-performance computer system, according to an embodiment of the disclosure, which receives (frequently wirelessly) seismic data regarding seismic waves from the seismic data recording sensors 105 in FIGS. 1 and 2 and/or the seismic data recording sensors in FIG. 3, which are also referred to as well log data recording sensors in FIG. 3. The high-performance computer system in FIG. 4 stores the seismic data in at least one memory for later processing and analysis by computer implemented methods and apparatuses of one or more embodiments. The analyzed or processed seismic data may be accessed by a personal computer system. More specifically, FIG. 4 shows a data transmission system 400 for wirelessly transmitting seismic data from seismic data recording sensors to a system computer 405 coupled to one or more storage devices 410 to store the seismic data in databases. The data transmission system may also transmit wirelessly seismic data from seismic data recording sensors 405 directly to one or more storage devices 410 to store the seismic data in databases, which may be accessed by system computer 405. The wireless transmission is denoted by reference numeral 402. The one or more storage devices 410 may also store other computer software instructions or programs to implement apparatuses and methods described in embodiments. The system computer 405 may be coupled (e.g., wirelessly coupled) to one or more output storage devices 420, which may receive the results of computer implemented processes or methods performed by the system computer 405. A personal computer 425 may be coupled (e.g., wirelessly coupled) to one or more output storage devices 420 and/or to the computer system 405 so that a user may utilize a user interface of the personal computer 425 to input information or obtain the results of the computer implemented processor methods performed by the system computer 405. The one or more storage devices 420 may also store other computer software instructions or programs to implement apparatuses and methods described in embodiments.

A user interface of the personal computer 425 may include, for example, one or more of a keyboard, a mouse, a joystick, a button, a switch, an electronic pen or stylus, a gesture recognition sensor (e.g., to recognize gestures of a user including movements of a body part), an input seismic device or voice recognition sensor (e.g., a microphone to receive a voice command), an output seismic device (e.g., a speaker), a track ball, a remote controller, a portable (e.g., a cellular or smart) phone, a tablet PC, a pedal or footswitch, a virtual-reality device, and so on. The user interface may further include a haptic device to provide haptic feedback to a user. The user interface may also include a touchscreen, for example. In addition, a personal computer 425 may be a desktop, a laptop, a tablet, a mobile phone or any other personal computing system.

Processes, functions, methods, and/or computer software instructions or programs in apparatuses and methods described in embodiments herein may be recorded, stored, or fixed in one or more non-transitory computer-readable media (computer readable storage (recording) media) that includes program instructions (computer readable instructions) to be implemented by a computer to cause one or more processors to execute (perform or implement) the program instructions. The media may also include, alone or in combination with the program instructions, data files, data structures, and the like. The media and program instructions may be those specially designed and constructed, or they may be of the kind well-known and available to those having skill in the computer software arts. Examples of non-transitory computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions may be executed by one or more processors. The described hardware devices may be configured to act as one or more software modules that are recorded, stored, or fixed in one or more non-transitory computer-readable media, in order to perform the operations and methods described above, or vice versa. In addition, a non-transitory computer-readable medium may be distributed among computer systems connected through a network and program instructions may be stored and executed in a decentralized manner. In addition, the computer-readable media may also be embodied in at least one application specific integrated circuit (ASIC) or Field Programmable Gate Array (FPGA).

The one or more databases may include a collection of data and supporting data structures which may be stored, for example, in the one or more storage devices 410 and 420. For example, the one or more storage devices 410 and 420 may be embodied in one or more non-transitory computer readable storage media, such as a nonvolatile memory device, such as a Read Only Memory (ROM), Programmable Read Only Memory (PROM), Erasable Programmable Read Only Memory (EPROM), and flash memory, a USB drive, a volatile memory device such as a Random Access Memory (RAM), a hard disk, floppy disks, a blue-ray disk, or optical media such as CD ROM discs and DVDs, or combinations thereof. However, examples of the storage devices 410 and 420 are not limited to the above description, and the storage may be realized by other various devices and structures as would be understood by those skilled in the art.

Recent advancements in seismic processing and machine learning have enabled more sophisticated methods for property prediction, particularly those guided by seismic attributes. These techniques offer the potential to enhance low-frequency model fidelity by incorporating spatially continuous information derived from seismic data, while simultaneously honoring the vertical resolution and ground truth provided by well logs. However, the challenge remains in developing a unified workflow that systematically integrates these disparate data sources-well information and seismic-guided predictions-into a coherent modeling framework that is both geologically plausible and inversion-ready.

The present disclosure addresses this need by introducing a novel low-frequency model building workflow that leverages well information in conjunction with seismic-guided property prediction. The disclosed methodology enables the generation of low-frequency models that are geologically consistent, spatially continuous, and optimized for subsequent inversion processes. By incorporating well-derived constraints and seismic attribute correlations, the workflow facilitates improved estimation of elastic properties such as P-wave velocity vₚ, S-wave velocity vₛ, and density rho, thereby enhancing the resolution and reliability of subsurface interpretations. This integrated approach represents a significant advancement in geophysical modeling, offering improved accuracy, reduced uncertainty, and greater applicability across diverse reservoir environments.

Low frequency model building is an important step for full wave form inversion of reservoir properties. The low frequency model is required to honor the true property trend for inversion process to converge to real solution. Conventionally, low frequency models are commonly built with Kriging using available well information and other property information, such as pressure velocity (vₚ, aka., P-wave velocity) from imaging process.

Kriging is a sophisticated geostatistical technique employed to interpolate continuous surfaces from discrete, spatially distributed data points by explicitly accounting for spatial correlation. This method is particularly valuable in contexts where the underlying variable exhibits spatial dependence, enabling more accurate predictions and quantifiable uncertainty. The Kriging process encompasses several methodical stages, beginning with exploratory data analysis to discern spatial patterns and relationships. This initial phase often involves constructing a variogram, which characterizes how the variance between data points changes as a function of distance, thereby revealing the spatial structure of the dataset.

Following data exploration, the next step involves variogram modeling, wherein a mathematical function is fitted to the empirical variogram. This model encapsulates key parameters such as the nugget, sill, and range, which collectively describe the degree and scale of spatial autocorrelation. Once the spatial model is established, it is used to compute weights for neighboring data points, allowing for the estimation of values at unsampled locations. These weights are derived not merely from proximity but from the spatial configuration and correlation structure defined by the variogram, ensuring that the interpolation honors the spatial continuity of the data.

A distinguishing feature of Kriging is its capacity to generate not only an interpolated surface but also a corresponding surface of prediction uncertainty. This variance map provides critical insight into the reliability of the estimates across the spatial domain, guiding decision-making in applications where uncertainty quantification is essential.

Several variants of Kriging have been developed to accommodate different assumptions and data characteristics. Ordinary Kriging operates under the assumption of a locally constant but unknown mean, making it suitable for stationary datasets. Universal Kriging relaxes this assumption by incorporating a deterministic trend component, allowing for non-stationary behavior across the surface. Block Kriging extends the methodology to estimate average values over spatial blocks rather than point locations, yielding smoother surfaces and facilitating regional analysis. Co-Kriging further enhances predictive performance by integrating secondary variables that exhibit spatial correlation with the primary variable, thereby leveraging additional information to refine the interpolation.

Kriging is extensively applied in disciplines such as soil science, geology, hydrology, and environmental monitoring, where spatial relationships play a pivotal role in understanding and managing natural phenomena. It is commonly used to estimate variables such as elevation, temperature, moisture content, and pollutant concentrations, providing a rigorous framework for spatial prediction and uncertainty assessment in both research and operational settings.

Compared with another commonly used inverse-distance interpolation method, Kriging interpolated result is more natural. Co-Kriging can allow incorporation of the background model, such as vₚ into the interpolation. However, vₚ from imaging process generally lacks good local fidelity and commonly results in bulls-eye phenomena in Kriging.

As discussed above, a seismic image volume is a three-dimensional representation of the Earth's subsurface created by processing seismic reflection data. It visualizes geological structures and stratigraphy in 3D, enabling interpreters to analyze spatial relationships and identify features like faults, horizons, and reservoirs. Seismic image volume is also referred to as seismic image, seismic volume, seismic image data, or seismic dataset in the present disclosure.

In exploration geophysics, a seismic image volume is the end product of processing and imaging seismic data acquired during a 3D seismic survey. During acquisition, seismic waves are generated at the surface and their reflections from subsurface layers are recorded by arrays of sensors (geophones or hydrophones). These raw data are then processed using sophisticated algorithms-such as migration or Full Waveform Inversion (FWI)—to reconstruct a spatially coherent image of the subsurface.

The resulting seismic image volume is structured as a 3D grid of voxels, where each voxel contains a seismic attribute (typically amplitude) that reflects contrasts in acoustic impedance between geological layers. The three axes of the volume correspond to:
Inline, usually aligned with acquisition direction,
Crossline, perpendicular to inline, and
Time or depth, vertical axis, representing two-way travel time or converted depth.

This volumetric dataset allows interpreters to extract 2D slices (e.g., time slices, depth slices, or arbitrary cross-sections) or generate 3D visualizations to analyze subsurface features. It is a foundational tool in hydrocarbon exploration, reservoir characterization, and geohazard assessment. Advanced seismic image volumes, such as those derived from FWI, incorporate the full physics of wave propagation and can resolve both large-scale structures and fine-scale heterogeneities with high fidelity. These high-resolution volumes are increasingly used not only for structural interpretation but also as input to quantitative workflows like seismic inversion, attribute analysis, and machine learning-based property prediction.

As will be discussed in more details below, the auxiliary seismic image volume is generated by applying certain wavelet operations on the primary seismic image volume, or the original seismic image volume.

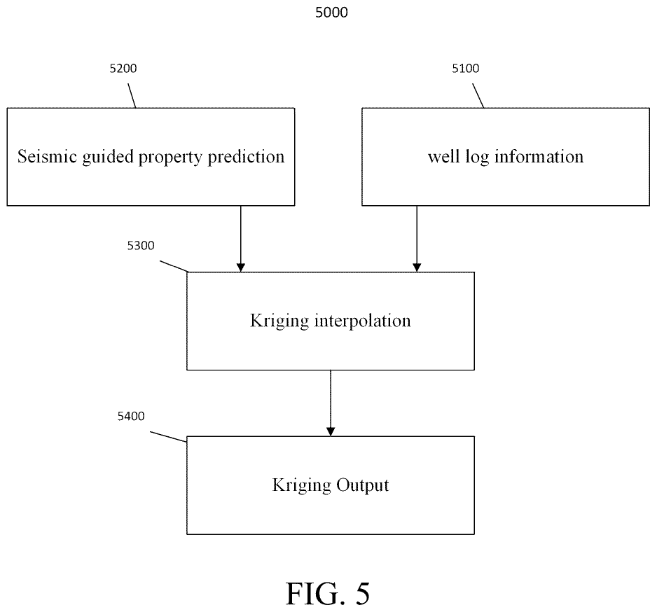

FIG. 5 is a functional block diagram illustrating Kriging workflow using well information, and the property produced by seismic guided property generation, according to an embodiment of the disclosure. In the workflow, inputs consist of two parts. One is the well log information, the other is the property projected from seismic domain used as background model for Co-Kriging interpolation process.

The illustrated workflow is designed to generate spatially continuous subsurface property models by leveraging both direct measurements and geo-physically inferred attributes. The input data utilized in this process comprises two distinct components. The first component consists of well log information 5100, which provides high-resolution, localized measurements of petrophysical properties such as acoustic impedance, porosity, or density. The second component 5200 is a property volume generated through seismic-guided property prediction techniques, which extrapolate subsurface characteristics from seismic data using inversion, machine learning, or other predictive algorithms. The third component is Kriging interpolation 5300. This seismic-derived property volume serves as a spatially extensive background model that informs the co-Kriging interpolation procedure. By incorporating both the localized precision of well data and the broader spatial continuity of seismic predictions, the co-Kriging framework enables robust estimation of subsurface properties at unsampled locations, while preserving geological consistency and honoring spatial correlation structures. Output 5400 is produced by the Kriging.

Building upon the previously described Kriging-based interpolation workflow, the process illustrated in FIG. 5 can be further characterized as a hybrid geostatistical modeling framework that synergistically combines high-resolution well log measurements with spatially extensive seismic-derived property volumes to produce geologically consistent subsurface models. This integration is achieved through a co-Kriging approach, which leverages the spatial correlation between the primary variable—typically a petrophysical property measured at well locations—and a secondary variable inferred from seismic data, thereby enhancing the predictive fidelity of the interpolated surface.

The workflow initiates with the acquisition and preprocessing of well log data, which serve as anchor points for localized property measurements. These data are typically sparse but possess high vertical resolution, capturing fine-scale variations in subsurface characteristics. In parallel, a seismic-guided property generation module produces a volumetric estimate of the same or related property across the broader survey area. This seismic-derived volume is generated using inversion algorithms, statistical learning models, or other predictive techniques that translate seismic attributes into petrophysical estimates. Although less precise than well data, the seismic volume offers continuous spatial coverage, making it an ideal candidate for use as a secondary variable in co-Kriging.

Once both datasets are prepared, the workflow proceeds to spatial analysis and variogram modeling. This step involves quantifying the spatial autocorrelation of each variable and their cross-correlation, typically through empirical variograms and cross-variograms. These statistical models capture the degree to which property values at different locations are related as a function of distance and direction. The resulting variogram structures are then used to compute optimal interpolation weights for each unsampled location, balancing the influence of nearby well measurements and the seismic background model.

The co-Kriging algorithm applies these weights to generate a continuous property surface that honors both the localized accuracy of well data and the spatial continuity of seismic predictions. Importantly, the method also yields a corresponding uncertainty surface, which quantifies the confidence level of each interpolated value. This dual output-estimated property and associated uncertainty-provides a robust foundation for downstream applications such as reservoir characterization, geomechanically modeling, and drilling risk assessment.

In summary, the workflow depicted in FIG. 5 exemplifies a data fusion strategy that exploits the complementary strengths of well and seismic data within a rigorous geostatistical framework. By employing co-Kriging, the method achieves enhanced spatial prediction of subsurface properties while maintaining geological plausibility and quantifiable uncertainty, thereby supporting more informed decision-making in subsurface exploration and development.

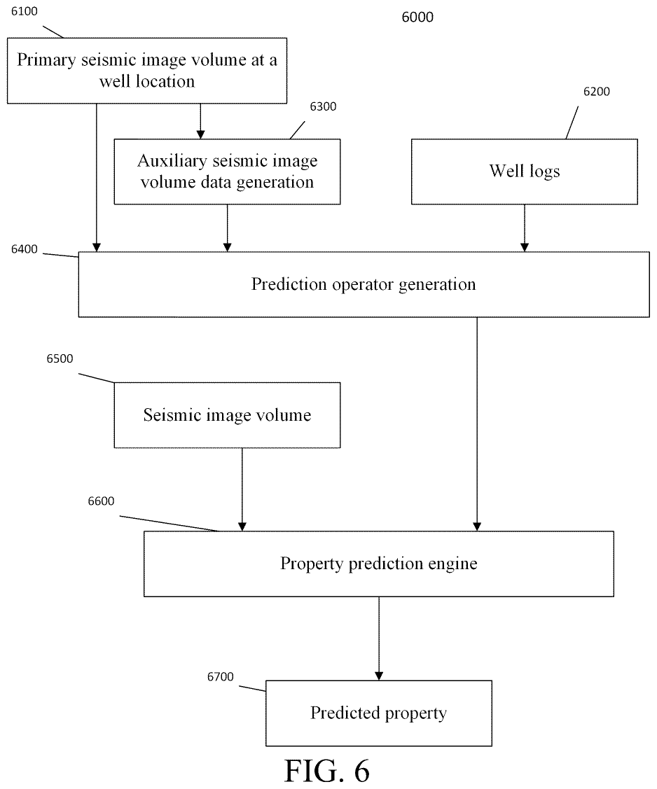

FIG. 6 is a functional block diagram illustrating seismic guided property prediction workflow, according to an embodiment of the disclosure. The generated prediction operator along with seismic volume is then input to the property prediction engine and obtains the predicted property volume.

This workflow 6000 is designed to generate a volumetric estimate of a subsurface property by leveraging both well log data and seismic information, thereby enabling spatially continuous prediction of petrophysical attributes across the survey area.

As further detailed in FIG. 6, the workflow 6000 begins with the generation of a prediction operator 6400. The inputs to this operator generation module comprise three primary data sources: (i) well log information generated at step 6200, which provides high-resolution, ground-truth measurements of the target property at discrete borehole locations, (ii) primary seismic image volume at a well location collected in step 6100, and (iii) auxiliary seismic image volume generated at step 6300 based on the primary seismic image volume. These inputs, the primary seismic image volume at a well location collected at step 6100, the well logs collected at step 6200, and the auxiliary seismic image volume generated at step 6300, are jointly analyzed to establish a statistical or machine learning-based relationship between the seismic signatures and the corresponding well log responses. As a result, a prediction operator is generated at step 6400.

The resulting prediction operator 6400 encapsulates this learned relationship and is subsequently applied to the full primary seismic image volume. Specifically, the prediction operator, in conjunction with the seismic image volume 6500, is fed into a property prediction engine 6600, which executes the transformation across the entire seismic domain. The seismic image volume in 6500 can be the primary seismic image volume, or the seismic image volume of a different location where the well location resides in, i.e., the second seismic image volume is obtained by seismic survey of an area that differs from where the primary seismic image volume is obtained from. The output of this process is a predicted property volume 6700-a spatially continuous three-dimensional representation of the target subsurface property, such as acoustic impedance, porosity, or lithofacies probability. This seismic-guided property prediction workflow 6000 enables the extrapolation of sparse well log measurements into regions devoid of direct sampling, while preserving geological trends and honoring the spatial variability captured by the seismic data. The resulting property volume 6700 may serve as a standalone interpretation product or as an input to subsequent geostatistical modeling workflows, such as co-Kriging or stochastic simulation, thereby enhancing the resolution and reliability of subsurface characterization.

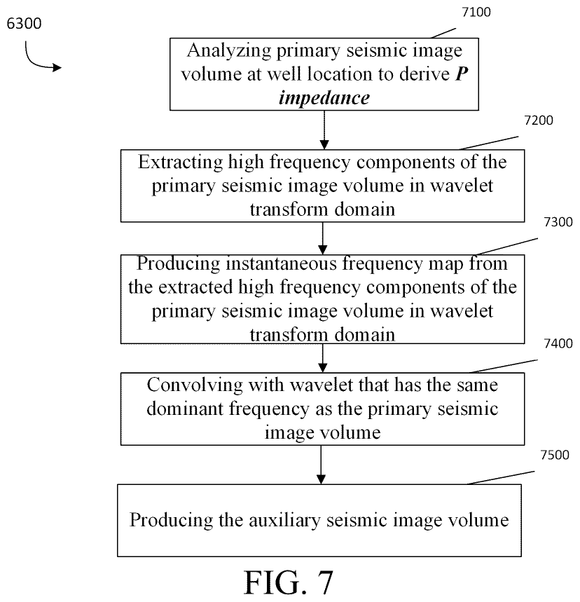

FIG. 7 is a flowchart illustrating the method for generating auxiliary seismic image volume, according to an embodiment of the disclosure. According to an embodiment of the disclosure, the present discourse proposes a workflow that uses primary seismic image volume to help build a reliable low frequency model of pressure velocity (vₚ), shear velocity(s) and density (rho). A seismic image volume provides regional structure information, which can be considered as a bridge to connect local wells together. A key step is building an operator to project from primary seismic image volume domain to seismic property (vₚ, vₛ, rho) domain.

In the context of seismic-guided property prediction, P impedance refers to longitudinal wave impedance, also known as acoustic impedance. It is a fundamental geophysical parameter that characterizes how seismic P-waves (primary or compressional waves) propagate through subsurface geological formations.

P impedance controls the reflection strength of seismic waves at geological boundaries. Variations in P impedance between adjacent layers cause seismic reflections, which are recorded in seismic surveys. Through seismic inversion techniques, P impedance volumes can be estimated from seismic data and used to infer subsurface properties such as lithology, porosity, and fluid content. P impedance is obtained from seismic data through a process called seismic inversion, which transforms seismic reflection data into quantitative rock property estimates.

In Kriging-assisted seismic-guided prediction workflows, P impedance often serves as a primary input attribute. It is spatially continuous and derived from seismic image volume, making it suitable for co-Kriging with sparse well log measurements. This integration improves the accuracy and geological consistency of interpolated property models, such as porosity or saturation distributions. According to an embodiment of the disclosure, the present disclosure presents a physical connection between Pimpedance and integration of seismic image volume. And in most cases, we can reasonably assume a pseudo-linear relationship between P impedance and (vₚ, vₛ, rho), where rho is density. Based on physics principle and reasonable assumptions, the present disclosure builds a projection operator between the primary seismic image volume and (vₚ, vₛ, rho). Assuming we have time domain vₚ, vₛ, rho and seismic at a well, which are denoted as vₚ(t), vₛ(t), rho(t), s(t) respectively, then

$$P impedance I ( t ) = {v}_{p} ( t ) \cdot rho ( t ) \qquad ( 1 )$$

$$reflectivity r ( t ) = {I}^{′} ( t ) \qquad ( 2 )$$

$$s ( t ) = r ( t ) * w ( t ) , w ( t ) is wavelet \qquad ( 3 )$$

$$so I ( t ) = \int r ( t ) ∼ \int s ( t ) \qquad ( 4 )$$

$$assuming : I ( t ) ∼ {v}_{p} ( t ) ∼ {v}_{s} ( t ) ∼ rho ( t )$$

$$then \int s ( t ) ∼ {v}_{p} ( t ) ∼ {v}_{s} ( t ) ∼ rho ( t ) \qquad ( 5 )$$

The limitation of seismic wavelet bandwidth leads to limited resolution of predicted property. To enhance the prediction resolution, another auxiliary seismic image volume (aka, auxiliary dataset) is generated. As illustrated in FIG. 6 and discussed in corresponding paragraphs above, the inputs to the prediction operator generation module includes three primary data sources: (i) well log information collected at step 6200, which provides high-resolution, ground-truth measurements of the target property at discrete borehole locations, (ii) primary seismic image volume collected at step 6100, and auxiliary seismic image volume collected at step 6300. These inputs are jointly analyzed to establish a statistical or machine learning-based relationship between the seismic signatures and the corresponding well log responses.

According to an embodiment of the disclosure, a prediction operator 6400 is generated at well locations with the goal of minimizing the difference between prediction and well information in the least square sense. The operator is then applied to the whole primary seismic image volume to generate desired properties at every location. It is required to have at least one well in the region of interest. Mathematically, the prediction operator estimation can be formed as:

$$[ \begin{matrix}{A}_{0} \\ \cdot \\ {A}_{i} \\ \cdot \\ {A}_{n}\end{matrix} ] [ p ] = [ \begin{matrix}{w}_{0} \\ \cdot \\ {w}_{i} \\ \cdot \\ {w}_{n}\end{matrix} ] \qquad ( 6 )$$

where A is formed by integration of seismic at corresponding well, including the primary seismic image volume and auxiliary seismic image volume, and w is well log at the well.

Once the prediction operator 6400 is determined, it is then applied to the seismic image volume away from the well locations:

$${A}_{j} p = {b}_{j} \qquad ( 7 )$$

In the workflow discussed above, it is initially postulated that a single, spatially uniform prediction operator can be effectively applied across the entire seismic survey area for property estimation. However, this assumption may not hold true in scenarios where a particular well is situated in a geological environment that is markedly distinct from those of other wells within the region of interest. Such environmental heterogeneity can lead to inaccuracies in property prediction if a uniform operator is indiscriminately employed, as local geological variations may not be adequately captured. To address this limitation, the present disclosure incorporates a geostatistical interpolation technique known as Co-Kriging, wherein the predicted property volume-derived from the application of the prediction operator to the seismic dataset-serves as a spatially continuous background model. Co-Kriging facilitates the integration of discrete well-log measurements with the continuous property estimates provided by the seismic-derived background model, thereby enabling the generation of a final property volume that is both locally consistent with well data and globally coherent with seismic trends.

Specifically, Co-Kriging operates by simultaneously honoring the high-resolution, ground-truth well log measurements at borehole locations and leveraging the broader spatial coverage of the background property model to interpolate values at unsampled locations. This dual-constraint approach ensures that the resulting property estimation achieves a high degree of local fidelity to the well data, while also preserving smooth spatial variations and geological continuity across the entire model domain.

The methodology is particularly advantageous in complex geological settings, as it systematically accounts for spatial non-stationarity and heterogeneity, thereby enhancing the accuracy and reliability of subsurface property predictions for use in reservoir characterization, geologic modeling, and related applications.

FIG. 7 is a flowchart illustrating the method for generating auxiliary seismic image volume, according to an embodiment of the disclosure. The method for generating auxiliary seismic image volume 7000, which is an implementation of 6300 in FIG. 6 above, includes a structured sequence of four computational steps, each designed to enhance the fidelity and interpretability of seismic-derived features for use in downstream geostatistical modeling workflows, such as co-Kriging. This method leverages both primary and auxiliary seismic image volume attributes to extract high-resolution spatial information that complements well log data in subsurface property prediction.

The seismic image volume dataset at a well location is obtained through a process that aligns and samples the seismic image volume at the spatial coordinates corresponding to the wellbore trajectory. This begins with a well-to-seismic tie, in which a synthetic seismogram is generated using well log data-typically sonic and density logs—and a known or estimated seismic wavelet. The synthetic trace is then correlated with the actual seismic trace at the well location to establish a time-depth relationship. This alignment ensures that the depth-based well log measurements correspond accurately to the time-based seismic image volume data.

To facilitate integration with well log data, the extracted seismic image volume is resampled or interpolated to match the sampling interval of the well logs. This harmonization enables the construction of a feature vector at each time or depth sample, which serves as input for training a prediction operator. The resulting matrix of seismic features is used to establish a statistical or machine learning-based relationship between seismic signatures and well log responses.

Finally, quality control procedures are applied to ensure that the seismic image volume at the well location is geologically consistent and free from artifacts or misalignments. This localized seismic image volume dataset becomes the foundation for training the prediction operator, which is subsequently applied across the full seismic volume to estimate subsurface properties in regions lacking direct well measurements.

In the first step 7100, the primary seismic image volume is subjected to comprehensive analysis to derive P impedance.

The second step 7200 involves the extraction of high-frequency components from the primary seismic image volume using a wavelet transform domain approach. Unlike conventional Fourier-based methods, the wavelet transform enables multi-resolution analysis by decomposing the primary seismic image volume into localized frequency bands across both time and space. This decomposition facilitates the isolation of high-frequency components that are indicative of fine-scale geological features, such as thin beds, fractures, or abrupt lithological transitions. The wavelet-based extraction preserves spatial localization, which is critical for maintaining geological plausibility in the resulting auxiliary data.

In the third step 7300, an instantaneous frequency map is generated from the wavelet-transformed primary seismic image volume. This map captures the dominant frequency content at each spatial location, reflecting subtle variations in subsurface composition and structure. The instantaneous frequency attribute is particularly valuable for identifying stratigraphic boundaries and detecting changes in lithology, as it responds sensitively to impedance contrasts and signal attenuation effects. The fourth step 7400 entails convolving the primary seismic image volume with a wavelet that matches the dominant frequency identified in the primary seismic image volume. This convolution process enhances the signal-to-noise ratio and reinforces the frequency characteristics most representative of the subsurface geology. By aligning the wavelet filter with the dominant frequency, the method ensures that the resulting auxiliary dataset retains coherence with the original primary seismic image volume while emphasizing geologically relevant features.

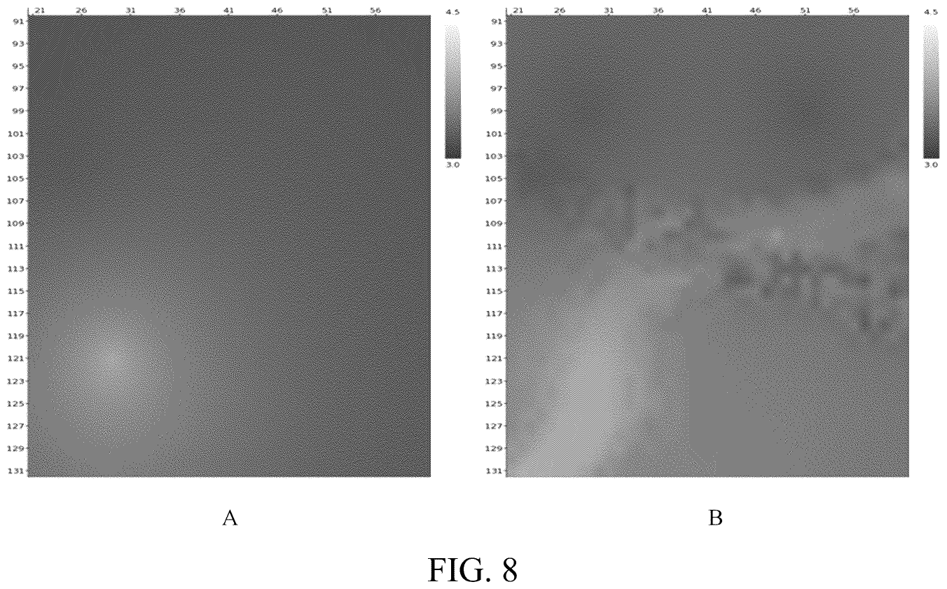

The use of wavelet transform domain for high-frequency component extraction offers significant advantages over traditional Fourier domain techniques. Specifically, the wavelet approach introduces an additional dimension of decomposition-time-frequency localization-which enables more precise and context-aware feature isolation. This results in auxiliary seismic image volume of superior quality, characterized by enhanced spatial resolution and improved interpretability, thereby supporting more accurate and geologically consistent property prediction in integrated geostatistical frameworks. FIG. 8 compares the results with conventional low frequency model building workflow, showing a bull's eye effect in panel A, vs. the result without bulls-eye effect, in panel B, with the inventive workflow that recovers true geological features, according to an embodiment of the disclosure.

In conventional low-frequency model (LFM) building workflows, the generated background property model often fails to accurately represent the true underlying geological architecture. Specifically, such models typically lack fidelity to actual subsurface structures-such as river channels—and exhibit poor local agreement with ground-truth well log measurements. This deficiency manifests as artificial anomalies, commonly referred to as “bulls-eye effects,” as illustrated in panel A of FIG. 8, wherein model predictions display spurious circular or elliptical artifacts centered around well locations. These artifacts indicate that the model does not honor geological continuity or local well data, thereby reducing its reliability for reservoir characterization and other subsurface prediction tasks.

In contrast, the inventive workflow described herein projects the background property model from the seismic domain in a manner that systematically honors both the true geological structure and the local well measurements. For example, in the case of a river channel, the proposed approach ensures that the background model accurately delineates the channel geometry and maintains local consistency with the well data. As a result, the bulls-eye artifacts are effectively eliminated, and the final property estimation exhibits both geological plausibility and high local fidelity, as illustrated in panel B of FIG. 8.

This improvement is achieved through the integration of advanced seismic attribute analysis and wavelet-based feature extraction, which together provide high-resolution auxiliary data that enhance the interpretability and accuracy of geostatistical modeling frameworks.

1. A method for predicting a property of a subsurface formation comprising:
drilling one or more wellbores into the subsurface formation at well location;
conducting a seismic survey at the well location to construct a primary seismic image volume, wherein the primary seismic image volume dataset comprises at least a pressure wave velocity vₚ, a shear velocity vₛ, and a density rho, in both time and frequency domains;
conducting well logging at the one or more wellbores and obtaining well logging information at the well location;
generating an auxiliary seismic image volume for seismic-guided property prediction using Kriging at the well location;
generating a prediction operator based on the primary seismic image volume, the auxiliary seismic image volume and the well logging information at the well location;
generating the predicted property of the subsurface formation using the prediction operator and a second seismic image volume.

2. The method according to claim 1, wherein the generating an auxiliary seismic image volume step further comprises:
deriving P impedance from the primary seismic image volume at the well location through seismic inversion in both time and frequency domains.

3. The method according to claim 1, wherein the generating an auxiliary seismic image volume step further comprises:
extracting high frequency components of the primary seismic image volume in wavelet transform domain.

4. The method according to claim 1, wherein the generating an auxiliary seismic image volume step further comprises:
producing instantaneous frequency map from the extracted high frequency components of the primary seismic image volume.

5. The method according to claim 1, wherein the generating an auxiliary seismic image volume step further comprises:
convolving the primary seismic image volume with a wavelet with the dominant frequency content.

6. The method according to claim 1, wherein the generating an auxiliary seismic image volume step further comprises:
producing the auxiliary seismic image volume at the well location with coherence with the primary seismic image volume at the well location.

7. The method of claim 1, wherein the conducting a seismic survey at the well location to construct a primary seismic image volume step further comprises: establishing a well-to-seismic tie.

8. The method of claim 1, wherein the conducting a seismic survey at the well location to construct a primary seismic image volume step further comprises: extracting seismic attributes at the well location from the primary seismic image volume.

9. The method of claim 1, wherein the high frequency components are indicative of fine-scale geological features.

10. The method of claim 1, wherein the conducting a seismic survey at the well location to construct a primary seismic image volume step further comprises: resampling or interpolating the extracted seismic attributes to match sampling intervals of the well logging information.

11. The method of claim 1, wherein the instantaneous frequency map captures a dominant frequency content at each spatial location.

12. The method of claim 1, wherein the conducting a seismic survey at the well location to construct a primary seismic image volume step further comprises:
ensuring the seismic dataset at the well location is geologically consistent and free from artifacts or misalignments.

13. The method of claim 1, further comprises:
establishing a pseudo-linear relationship between P impedance and (vₚ, vₛ, rho), wherein vₚ is pressure velocity., vₛ is shear velocity, and rho is density.

14. The method of claim 1, further comprises:
constructing a prediction operator between the primary seismic image volume dataset and (vₚ, vₛ, rho).

15. The method of claim 1, wherein, P impedance/(t)=vₚ(t)·rho(t), wherein: I(t) is time domain P impedance, vₚ(t) is time domain pressure velocity, and rho(t) is time domain density.

16. The method of claim 1, wherein,
$$reflectivity r ( t ) = {I}^{′} ( t ) ,$$
$$s ( t ) = r ( t ) * w ( t ) , w ( t ) is wavelet ,$$
$$I ( t ) = \int r ( t ) ∼ \int s ( t ) .$$

17. The method of claim 1, wherein,
$$assuming : I ( t ) ∼ {v}_{p} ( t ) ∼ {v}_{s} ( t ) ∼ rho ( t ) ,$$
$$then \int s ( t ) ∼ {v}_{p} ( t ) ∼ {v}_{s} ( t ) ∼ rho ( t ) .$$

18. The method of claim 1, wherein the second seismic image volume is the same as the primary seismic image volume.

19. The method of claim 1, wherein the second seismic image volume is obtained from an area differing from wherein the well location resides in.
